(19) United States
(12) Patent Application Publication
(10) Pub. No.: US 2017/0144910 A1
(43) Pub. Date: May 25, 2017

(54) MULTISTAGE AERATION SYSTEM

(71) Applicant: KUWAIT UNIVERSITY, SAFAT (KW)

(72) Inventor: BADER SHAFAQA AL-ANZI, SAFAT (KW)

(21) Appl. No.: 14/951,460

(22) Filed: Nov. 24, 2015

(51) Int. Cl. C02F 3/20; C02F 3/00

(52) U.S. Cl. CPC C02F 3/20; C02F 3/006; C02F 2209/03

(57) ABSTRACT

The multistage aeration system includes a water jet tank system having a closed water tank that holds a pool of water and seals in air above the pool of water. A nozzle in the top portion includes air bleeder passages to allow an ambient air to flow through the nozzle and into the closed water tank. A water flow meter and a water pump circulate water from the closed water tank to outside the tank through the water flow meter and then through the nozzle. The nozzle entrains air through the bleeder passages into the water as the water passes through the nozzle, and forms a jet spray into the pool of water. An air flow meter valve and a closed water tank air outlet pipe extend from the closed water tank and connect the water jet tank system to a diffused aeration tank system with a series tank system.

### BACKGROUND OF THE INVENTION

1. Field of the Invention

The present invention relates to aeration systems, and particularly to a multistage aeration system.

2. Description of the Related Art

Aeration is one of the processes that can be employed in various air-water contactors. For example, aeration processes can be implemented within aquariums, flotation systems, and for biological treatment in wastewater systems, among other examples. In wastewater systems, the process air can be introduced during the secondary stage, also referred to as the biological stage, using convectional technologies to increase the concentration of Dissolved Oxygen (DO). This DO concentration is usually increased to an amount of about 2.0 parts per million (ppm). The DO concentration is needed for the bacteria to breathe, and also to consume the organic compounds.

Presently, diffused aeration is used to introduce air into the system under a relatively high pressure from the bottom of the basin, which is also referred to as a clarifier, through pores on a pipe network utilizing compressors. However, there can be drawbacks with this approach. For example, this type of technology is relatively costly because it involves an extra cost by operating air compressors to provide the pressurized gas/air. Other examples of aeration processes include mechanical aeration processes utilizing impellers and plunging liquid jet. However, there can be drawbacks with these approaches as well.

Certain environmental problems, such as contamination of seawater by wastewater, can require efficient and immediate aeration. Seawater contamination can ultimately lead to oxygen depletion and can consequently destroy aquatic life; for example as seen in the fish kill phenomenon, unless dissolved oxygen is restored quickly. In this case an aeration technology is required to promote aeration phenomena and to increase the DO concentration into water immediately.

Aerators can also be used to remove unwanted gases from the atmosphere and to dissolve them into water. However, most of the existing aerators can consume a lot of energy with limited aeration due to the use of compressors for diffused aeration and propellers for mechanical aeration. Hence all of these processes appear to be costly, not very efficient, and fixed, meaning that they are not portable. In addition, conventional aeration systems are recognized as being considerably burdensome in their maintenance and management. These issues have encouraged researchers to seek an alternative system that provides efficient oxygen transfer at a relatively lower cost.

Thus, a multistage aeration system solving the aforementioned problems is desired.

### SUMMARY OF THE INVENTION

The multistage aeration system includes a water jet tank system having a closed water tank. The closed water tank has a bottom portion that holds a pool of water and a top portion that seals in air above the pool of water (the headspace). A nozzle is disposed in the top portion of the closed water tank. The nozzle has air bleeder passages allowing ambient air to flow through the nozzle and into the closed water tank. A headspace pressure sensor in the top portion of the closed water tank measures headspace pressure developed inside the closed water tank. The multistage aeration system further includes a water flow meter and a water pump circulating water from the bottom portion of the closed water tank to outside the tank through the water flow meter and then through the nozzle at the top portion of the closed water tank. The nozzle entrains air through the bleeder passages into the water as the water passes through the nozzle, and forms a jet spray into the pool of water in the bottom portion of the closed water tank in order to aerate the pool of water. The headspace pressure is developed in the top portion of the closed water tank when the closed water tank is partially filled with water.

The multistage aeration system also includes a diffused aeration tank system that involves a plurality of tanks. An air flow meter valve and a closed water tank air outlet pipe extend from inside the top portion of the closed water tank through the air flow meter valve and connect the water jet tank system to the diffused aeration tank system. The closed water tank air outlet pipe has perforated portions extending along an inside portion of the plurality of tanks, the perforated portions being adapted for diffusion of air into the tanks in the diffused aeration tank system. Additional features of the multistage aeration system include the tank system having a plurality of closed tank units connected either in series or in parallel by the closed water tank air outlet pipe and at least one terminal tank unit that is an open tank unit. When headspace pressure in the water jet tank system exceeds a predetermined limit (due to excess gas that is not dissolved in the pool of water and would otherwise be unused), the air flow meter is opened to allow the unused gas in the headspace to flow through the plurality of tanks in the diffuse aeration system.

These and other features of the present invention will become readily apparent upon further review of the following specification and drawings.

### BRIEF DESCRIPTION OF THE DRAWINGS

FIG. 1 is a diagrammatic side view in section of a multistage aeration system according to the present invention.

FIG. 2 is a diagrammatic side view in section of an alternative embodiment of a multistage aeration system according to the present invention.

Similar reference characters denote corresponding features consistently throughout the attached drawings.

### DETAILED DESCRIPTION OF THE PREFERRED EMBODIMENTS

The multistage aeration system provides for an aeration technology that can be useful, handy and economically feasible. The multistage aeration system can be used for environmental problems that need relatively immediate and efficient treatment, such as contamination of seawater with wastewater, and the removal of harmful gases. The multistage aeration system uses only a single water pump, and the ambient air/gas is entrained by a circulating water jet that utilizes the single water pump, and then enters a closed/sealed container/tank. The entrained gas is broken into bubbles after an impingement between the water jet and the water pool occurs.

The entrained gas/air builds up the headspace pressure above the water pool, and is measured by a pressure gauge. The trapped air above the water pool is released when the headspace pressure increases to reach a predetermined value to aerate separate tanks/containers connected in series/parallel as a diffused aeration or any other aeration process. In this way, oxygen efficiency can be increased to exceed oxygen efficiency achieved by an integrated aeration process.

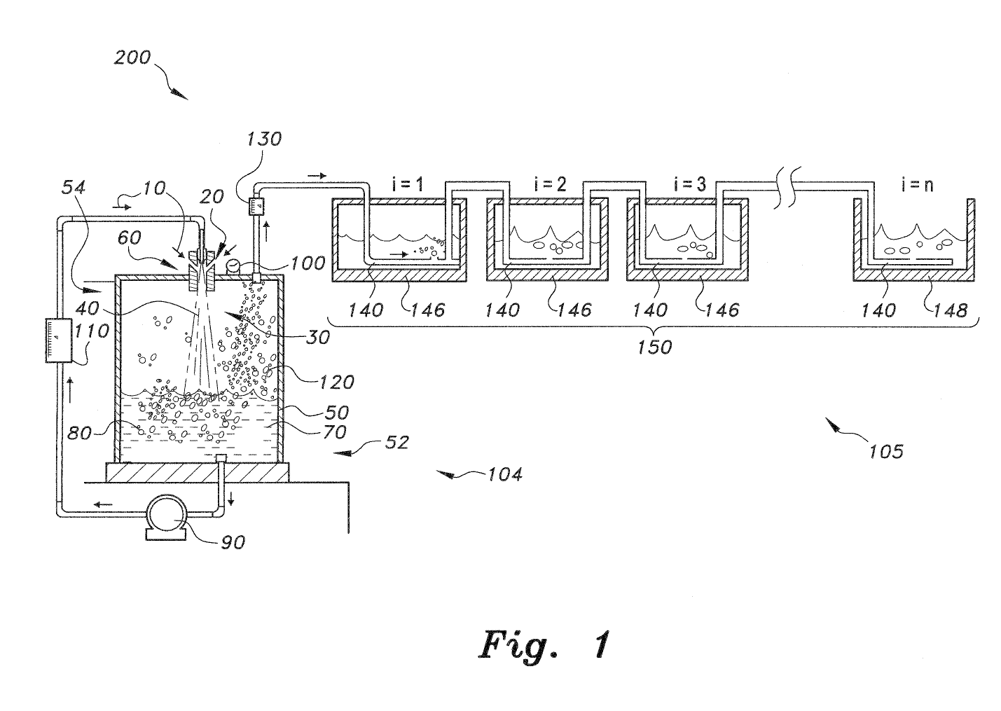

Referring to FIG. 1, the multistage aeration system 200 utilizes a simple single water pump 90 for aeration. Ambient air/gas 10 is entrained by a circulating water jet 40 induced by the water pump 90. The circulating water jet 40 enters a sealed, airtight tank, illustrated as the closed water tank 50. The entrained gas is broken into air bubbles 120 after impingement between the jet 40 and a receiving water pool 70 occurs. The entrained gas/air builds up headspace pressure in the headspace area 30 above the water pool 70. The headspace pressure in the headspace area 30 can be measured by a pressure sensor 100. Further, the trapped air above the water pool 70 is released when the headspace pressure increases to a predetermined value to aerate a separate tank/container by diffused aeration (or other aeration process), shown as a tank system 150 having a plurality of tanks connected in series, although it will be understood that the aeration tanks in the tank system 150 may be configured in parallel, if desired.

The multistage aeration system 200 includes two different systems, a water jet tank system 104 and a diffused aeration tank system 105. Both systems 104 and 105 are connected together to establish a pressurized air from the water pump 90. The water jet tank system 104 includes the closed water tank 50, which has a bottom portion 52 disposed on a platform and a top portion 54. In the top portion 54 of the closed water tank 50, a downward spraying jet 40 of water having air entrained in the jet is introduced through the top portion 54. The water pump 90 includes an inlet and an outlet, the inlet extending from the inside bottom portion 52 of the closed water tank 50.

The pump 90 causes water to flow from the closed water tank 50 through an outlet circuit of the water pump 90. The outlet circuit of the water pump 90 includes a water flow meter 110. The outlet circuit of the water pump 90, via the water flow meter 110 and conduit, feeds into a connected nozzle 60 that enters the top portion 54 of the closed water tank 50. As illustrated, the nozzle 60 has air bleeder passages 20. Ambient air/gas 10 flows through the bleeder passages 20 and is entrained in the flow of water from the water pump 90 so that the nozzle 60 can cause a downward projecting water jet 40. This downward projecting water jet 40 develops within and inside the closed water tank 50 of the water jet tank system 104.

As illustrated, the water from the downward projecting water jet 40 impinges the water in the water pool 70, which serves as a receiving pool. During this impingement process, underwater air bubbles 80 are forced to the water surface of the water pool 70, and are released as air bubbles 120. As the pool of water 70 becomes increasingly saturated with oxygen from the air entrained in the jet 40, the air bubbles 120 from unused air can accumulate in the headspace area 30 above the water pool 70 until a relatively sufficient pressure is built up inside the closed water tank 50. The underwater air bubbles 80 penetrate to a certain depth in the water pool 70 and rise back up due to a bubble terminal velocity, i.e. buoyancy.

Generally speaking, a gas is sparingly soluble in water, and hence relatively little oxygen, in case of aeration, is transferred to the surrounding liquid, depending on operational variables of the multistage aeration system 200. The unused/remaining gas leaves the water pool 70 and is trapped in the headspace area 30. The unused/remaining/undissolved gas leaves the water pool 70 to be trapped in the headspace 30 to reuse the remaining unused gas coming from the closed tank system 104. This can allow for an increased chance, i.e. a detention or retention time, for the air to contact a liquid, i.e., by aeration to increase the process efficiency, and hence save money

As mentioned previously, a pressure sensor 100 measures pressure inside the closed water tank 50. An outlet pipe 140 extends from inside the top portion 54 of the closed water tank 50 of the water jet tank system 104. As illustrated, the outlet pipe 140 flows through an airflow meter valve 130 and also includes a perforated portion, or a plurality of spaced apart perforated portions defining a diffuser pipe. The outlet pipe 140 extends to the second component of the multistage aeration system 200, which is a diffuser aeration tank system 105. Thus, the outlet pipe 140 connects the two components of the multistage aeration system 200, connecting the water jet tank system 104 and the diffused aeration tank system 105 together.

The diffused aeration tank system 105 includes a tank system 150, and as shown in FIG. 1, the outlet pipe 140 is positioned within the tank system 150. More specifically, the perforated portions of the outlet pipe 140 are positioned within pools of water in the aeration tanks of the tank system 150. The perforated portions are adapted for diffusion of air/gas into the aeration tanks of the tank system 150 in order to aerate the water in the tanks.

The tank system 150 has a plurality of stages of closed/sealed tanks connected in series/parallel. More specifically, a plurality of closed tank units 146 can be connected in series or in parallel to make up the tank system 150. Depending on the user's needs, the initial number “i” of closed tank units 146 can be 1, and can be increased to any number “n” that the user believes is suitable for their aeration needs.

As shown, the outlet pipe 140 and the perforated portions of the outlet pipe are positioned within each closed tank unit 146. If need be, additional pumps can be used to forward the air/gas from the one closed tank unit 146 to the next closed tank unit 146. The closed tank units 146 can continue to be added, thus increasing the “n” number, until the user is satisfied. The final closed tank unit 146 will then be connected to an open tank unit 148, as illustrated. Therefore, the relationship between the closed tank units 146 and the open tank unit 148 of the series tank system 150, and the DO concentration that results, can be represented by the following functions below:

DO_{T}=ΣᵢⁿDOᵢ, i=1,2,3, . . . , n, (1)

and therefore,

DO_{T}=DO₁+DO₂+DO₃+ . . . +DOₙ, (2)

where the amount of oxygen dissolved in each tank is DO₁, i refers to the closed tank unit number, and DO_{T} is the total dissolved oxygen of the entire system.

The unused gas coming from the water jet tank system 104 enters the tank system 150 through the air flow meter valve 130 and perforated pipe 140 to form the multistage aeration system 200. The air flow meter valve 130 may be opened manually when the headspace pressure in the water jet tank system 104 reaches the predetermined value, or the air flow meter valve 130 may be a solenoid valve that is actuated by a microcontroller upon receiving a sensor signal from the pressure sensor 100.

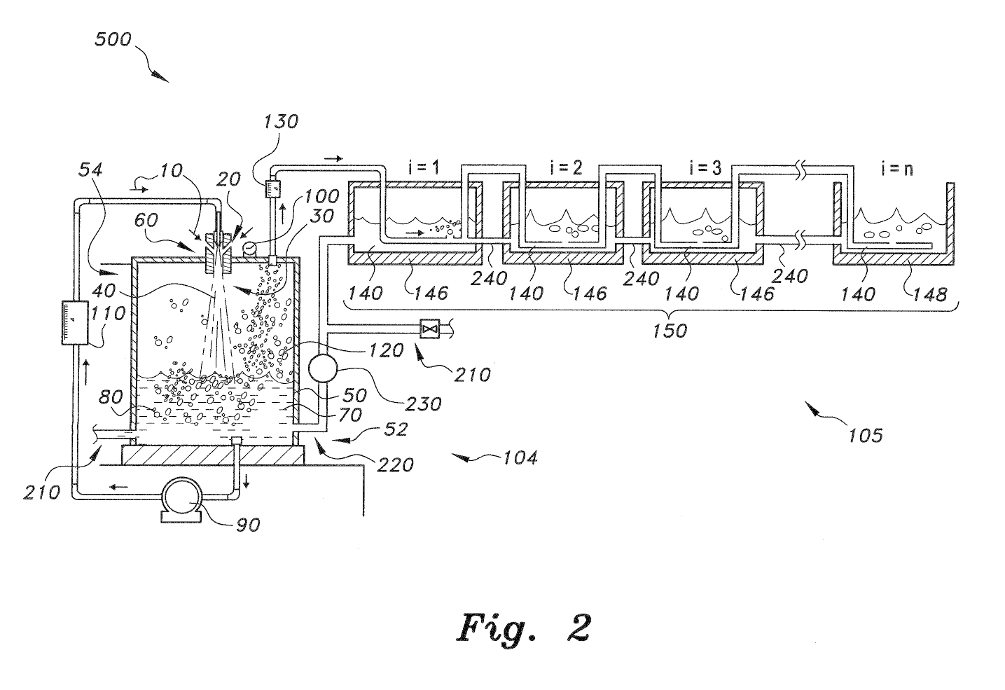

Referring to FIG. 2, a multistage aeration system 500, similar to the multistage aeration system 200, is shown. Whereas FIG. 1 essentially shows a batch reactor, FIG. 2 shows a continuous flow reactor. The multistage aeration system 500 includes the same structures and features as described in the multistage aeration system 200, such as a water jet tank system 104 and a diffused aeration tank system 105, water pump 90, ambient air/gas 10, circulating water jet 40, and closed water tank 50, among other features and structures. However, the multistage aeration system 500 includes additional structures, as shown in FIG. 2, in addition to the structures found in multistage aeration system 200.

The additional structures of the multistage aeration system 500 can allow for delivery of continuous raw liquid streams, such as untreated water, into the multistage aeration system 500 at various points in the process. For example, raw liquid inlets 210 can allow for a raw liquid, such as untreated water, to be continuously added to the multistage aeration system 500 for treatment. The raw liquid inlets 210 can be added on either or both sides of the closed tank 50. The raw liquid inlets 210 can include valves to control the flow of raw liquid. Therefore, there is a continuous influent and effluent flow into and out of the multistage aeration system 500 of raw liquid, as shown by a raw liquid inlet 210 entering the closed tank 50, and another raw liquid inlet 210 delivering raw liquid at another point in the process.

The closed tank 50 now includes a raw liquid outlet 220 that allows the raw liquid to exit the closed tank 50. The raw liquid outlet 220 carries the raw liquid to a pump 230 so that the raw liquid can be delivered to the diffused aeration tank system 105. As shown in FIG. 2, the raw liquid exiting from the closed tank 50 is further mixed with additional raw liquid by another raw liquid inlet 210. Therefore, the liquid that arrives to the diffused aeration tank system 105 includes further raw liquid for treatment. The raw liquid is then distributed across the diffused aeration tank system 105, i.e., throughout the tank system 150. As shown in FIG. 2, the raw liquid is carried throughout the tank system 150 by a series of pipes 240 that connect the individual closed tank units 146 to one another to allow for communication between the tank units 146. Thus, raw liquid can be distributed into each closed tank unit 146 of the tank system 150. Therefore, the raw liquid is carried all the way to the individual tank units 146 for treatment and continuous flow of fresh raw liquid to replace the treated liquid in each tank unit 146 so that the multistage aeration system 500 continuously treats raw liquid. Thus, the multistage aeration system 500 receives raw liquid and dispenses treated liquid.

It should be noted that the raw liquid inlets 210 can be placed anywhere within the multistage aeration system 500 to allow for the treatment of the raw liquid. For example, a pair of raw liquid inlets 210 can both be placed after the closed water tank 50, such as after the pump 230. Further, the multistage aeration system 500 validates the oxygen equations (DOT) (1) and (2) described above.

It is to be understood that the present invention is not limited to the embodiments described above, but encompasses any and all embodiments within the scope of the following claims.

I claim:

1. A multistage aeration system, comprising:
a water jet tank system, having:
a closed water tank having a lower portion adapted for holding a pool of water and a headspace defined above the lower portion;
a water recirculation system including a water outlet extending from the lower portion of the closed water tank, a water pump connected to the water outlet, and a jet nozzle connected to the water pump, the jet nozzle extending into the headspace for injecting a jet of water having air entrained therein into the headspace to aerate water in the closed water tank by jet spray;
an air pressure sensor extending into the headspace; and
an air flow meter valve extending into the headspace;
a diffuse aeration tank system having a plurality of aeration tanks adapted for holding water; and
an air outlet pipe extending from the air flow meter valve through the plurality of aeration tanks in the diffuse aeration tank system, the outlet pipe having a perforated portion disposed in each of the aeration tanks in the diffuse aeration tank system, the air flow meter valve having a closed position retaining unused entrained air in the headspace of the closed water tank and an open position permitting a metered flow of the unused entrained air through the air outlet pipe to aerate water in the aeration tanks by diffuse aeration when pressure in the headspace exceeds a predetermined value.

2. The multistage aeration system according to claim 1, further comprising a water flow meter disposed between said water pump and said jet nozzle.

3. The multistage aeration system according to claim 1, wherein said plurality of aeration tanks comprise at least one closed water tank and at least one terminal open water tank, said air outlet pipe terminating in the at least one terminal open water tank.

4. The multistage aeration system according to claim 1, wherein said plurality of aeration tanks are connected in series.

5. The multistage aeration system according to claim 1, wherein said multistage aeration system comprises a batch reactor.

6. The multistage aeration system according to claim 1, wherein said multistage aeration system comprises a continuous flow reactor.

7. A method of aerating water in multiple stages, comprising the steps of:
aerating water in a first closed water tank by jet spray aeration;
monitoring air pressure in a headspace defined above the water in the first closed tank; and
releasing a metered flow of air from the headspace through a diffuser pipe to a plurality of aeration tanks to aerate water in the aeration tanks by diffuser aeration when air pressure in the headspace exceeds a predetermined value.
